(19) United States
(12) Patent Application Publication
(10) Pub. No.: US 2012/0141143 A1
(43) Pub. Date: Jun. 7, 2012

(54) OPTICAL COMMUNICATION MODULE

(75) Inventors: Shigeo Hayashi, Yokkaichi-shi (JP); Toshio Takagi, Yokohama-shi (JP)

(73) Assignees: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP)

(21) Appl. No.: 13/390,192

(22) PCT Filed: Jul. 13, 2010
(86) PCT No.: PCT/JP2010/061810

§ 371 Date: Feb. 13, 2012

(30) Foreign Application Priority Data
Nov. 3, 2009 (JP) 2009-252529

(51) Int. Cl. H04B 10/04

(52) U.S. Cl. 398/201

(57) ABSTRACT

It is expected to provide an optical communication module that does not require making a conductive plate, such as a leadframe, become thinner in response to the downsizing of the photoelectric conversion device, such as a laser diode or a photodiode, and does not require downsizing a lens. A laser diode is connected and fixed to a conductive plate on the top surface of a transparent light-passing board. The light-passing board is connected and fixed to a conductive plate on the top surface of a transparent base. A first lens and a second lens are integrally formed on the top and the bottom surfaces of the base, respectively. The laser diode performs transmission of optical signals through the gap of conductive plate, the transparent light-passing board, the opening portion of a conductive plate, the opening portion of conductive plate, the first lens, the transparent base and the second lens.

### BACKGROUND OF THE INVENTION

1. Field of the Invention

The present invention relates to an optical communication module that packages an element, such as a laser diode and/or photodiode for performing optical communication.

2. Description of Related Art

Conventionally, the optical communication has become widespread, which utilizes an optical fiber and the like. The optical communication is performed with a light emitter, such as a laser diode, converting an electrical signal into an optical signal, with an optical fiber through which the optical signal is transmitted, and with a light receiver, such as a photodiode, converting the received optical signal into the electrical signal (hereinafter, these light emitter and light receiver are called as photoelectric conversion devices). Thus, it is well known to utilize an optical communication module that packages the photoelectric conversion devices, such as the laser diode and/or the photodiode together with a peripheral circuit element for operating the photoelectric conversion device. Such an optical communication module is called as the optical sub-assembly (OSA). Recently, several inventions are proposed for the optical communication and the optical communication module.

For example, Patent Document 1 proposes a configuration in which an output of a first photodiode for receiving light and an output of a second photodiode shielded from light are input into a differential amplifier through a gain control amplifier, and a lowpass filter is arranged between an output terminal of an optical power detecting unit that detects an optical power and a gain control terminal of the gain control amplifier, for implementing an optical detector that can be applied to a high-speed and dynamic-range communication.

In addition, Patent Document 2 proposes an optical reception apparatus that can adequately control the amount of operating current/voltage and reduce the electrical power consumption, with a configuration in which a photodiode for receiving a signal, a photodiode for detecting an optical level, a signal amplifier that amplifies a received signal and a bias current control unit that controls bias current provided to the signal amplifier are mounted on a single board, and the bias current control unit makes the signal amplifier operate when the signal current output from the photodiode for detecting the optical level is equal to or more than a predetermined value. In that optical reception apparatus, the photodiode for receiving the signal further includes a photosensitive area formed in a substantial circular shape smaller than the diffusion of the optical signal, and the photodiode for detecting the optical level further includes a photosensitive area that surrounds the photosensitive area of the photodiode for receiving the signal, for efficiently detecting the optical signal and enhancing the reception ability.

The inventions according to Patent Documents 1 and 2 relate to a peripheral circuit of a photoelectric conversion device, and expect to enhance the ability of the optical communication lead by the modification of the peripheral circuit. The inventions according to Patent Documents 1 and 2 utilize an optical communication module in which the board mounting the photoelectric conversion device and the peripheral circuit is fixed to a leadframe and sealed by transparent resin to form a molded part, and a hemisphere lens is arranged on the surface of the molded part. This optical communication module is configured to make the lens become opposite to an exit terminal of the optical fiber.
Patent Document 1: Japanese Patent Application Laid-Open No. 2006-40976
Patent Document 2: International Publication No. WO 01/015348

### SUMMARY OF THE INVENTION

In a conventional optical communication module, the photoelectric conversion device (and the peripheral circuit) is (are) often mounted on the leadframe, and the photoelectric conversion device and the leadframe are often sealed by transparent resin. In addition, the lens is often configured integrally by resin. That configuration may cause a problem that the accuracy of the optical communication is reduced, because it causes the positional offset of the lens and the photoelectric conversion device if the accuracy for forming resin is low. Furthermore, that configuration may cause a problem that the range of resin selection is narrow, because the photoelectric conversion device is kept in a high temperature environment during the resin sealing and the resin should be selected in view of the heat performance of the photoelectric conversion device. Therefore, it is difficult to solve the problems with the resin that can enhance the forming accuracy. The inventions of Patent Documents 1 and 2 are configured to seal the photoelectric conversion device by resin to form the molded portion and arrange the lens on the surface of the molded portion. Therefore, it may cause the positional offset of the lens and the photoelectric conversion device and reduce the accuracy for the optical communication, when the accuracy for forming the lens with resin is low.

In order to solve these problems, the inventors of this application have already invented an optical communication module described below. FIG. 11 is a schematic cross section view for explaining the configuration of the optical communication module that implements enhancing the communication accuracy and reducing the manufacturing cost. The numeral “101” in the figure is an OSA in which a laser diode 20 is packaged. The OSA 101 is configured to include: a base 10 that is formed in a plate shape with transparent synthetic resin; a conductive plate 30, such as a leadframe, which is buried at the upper side of the base 10 to be exposed partially and whose exposed portion is connected to connectors 21a, 21b of the laser diode 20; a peripheral wall 12 that is integrally formed with the base 10 to surround the laser diode 20; a cover 40 that seals a recess portion 12a surrounded by the base 10 and the peripheral wall 12 and the like.

The laser diode 20 is formed in a substantial rectangular parallelepiped shape, includes a light emitting unit at the substantial center on the bottom surface, and includes the connectors 21a, 21b around the light emitting unit, which are utilized for taking and giving electrical signals. In addition, a first lens 14 and a second lens 15 are formed integrally at the front and back sides (top and bottom surfaces) of the base 10. A light emitting unit of the laser diode 20 connected to the conductive plate 30 is arranged opposite to the first lens 14 through the opening portion 31 formed at the conductive plate 30, and a position of the laser diode 20 is determined to match the center of the light emitting unit with the centers of the first lens 14 and the second lens.

In the manufacturing processing of the OSA 101, the conductive plate 30 previously formed in a desired shape is put into a mold tool utilized for resin formation at a predetermined position, and transparent synthetic resin is poured into the mold tool and then cured, to integrally form the base 10, the peripheral wall 12, the first lens 14, the second lens 15 and the like. Then, the position of the laser diode 20 is determined and the laser diode 20 is connected to the conductive plate 30, and then the recess portion 12a is sealed by the cover 40, to complete OSA 101.

The laser diode 20 can be connected to the conductive plate 30 in the OSA 101 described above after the resin formation is performed for the base 10, the peripheral wall 12 and the like. Thus, it is possible to select the resin without considering the heat performance of the laser diode 20. Hence, it is possible to select the resin that can be utilized for the formation with high accuracy, and to enhance the accuracy for forming the first lens 14, the second lens 15 and the like. Therefore, it is possible to enhance the communication accuracy of the optical communication module.

However, as the size of the laser diode 20 is reduced, the distance of the connectors 21a, 21b arranged around the light emitting unit of the laser diode 20 becomes shorter. Thus, the width of the opening portion 31 formed on the conductive plate 30 should be shorter. In order to precisely form the opening portion 31 whose width is shorter, the conductive plate 30 should be thinner. However, the thinner conductive plate 30 may cause reduction in the strength of the connection terminal because one end of the conductive plate 30 is exposed to the outside of the OSA 1 and utilized as a connection terminal connected to an external apparatus. Therefore, it is difficult to adopt the approach of making the thinner conductive plate 30.

In addition, the base 10 of OSA 1 includes a top side portion on which the laser diode 20 is arranged and a bottom side portion which is opposite to the top side portion, and these portions are formed with mold tools different from each other. Thus, the diameter of the first lens 14 integrally formed on the top side portion of the base 10 cannot become larger than the width of the opening portion 31 of the conductive plate 30. Hence, when the width of the opening portion 31 of the conductive plate 30 is shorter in response to the downsizing of the laser diode 20, the downsizing must be performed on the first lens 14, too. Therefore, it may cause reduction in the accuracy of the optical communication.

The present invention is made in view of such circumstances, and has an object to provide an optical communication module that does not require to make a conductive plate such as a leadframe become thinner and to downsize a lens, even as the photoelectric conversion device such as the photodiode or the laser diode is downsized.

An optical communication module according to the present invention comprises: a photoelectric conversion device that includes an area for receiving and emitting light and a connector connected to another device, and that converts from an optical signal into an electrical signal or from an electrical signal into an optical signal; a light-passing board that includes a first conductive plate connected to a connector of the photoelectric conversion device, and a light-passing portion passing light to the area of the photoelectric conversion device connected to the first conductive plate; and a holding unit that is transparent, mounts the light-passing board and holds a second conductive plate of the light-passing portion, the light-passing portion arranged at a position corresponding to a light-passing portion of the light-passing board, wherein the photoelectric conversion device sends and receives an optical signal through the light-passing portion of the light-passing board, the light-passing portion of the second conductive plate, and the holding unit being transparent.

In addition, an optical communication module according to the present invention further comprises a lens that is integrally formed on the holding unit and is arranged opposite to the area of the photoelectric conversion device through the light-passing portion of the light-passing board and the light-passing portion of the second conductive plate.

In addition, an optical communication module according to the present invention further comprises another lens that is integrally formed on the holding unit and is arranged opposite to the lens.

In addition, an optical communication module according to the present invention further comprises a connecting means for electrically connecting the first conductive plate and the second conductive plate.

In addition, an optical communication module according to the present invention further comprises a sealing means for sealing the photoelectric conversion device and the light-passing board.

In addition, an optical communication module according to the present invention comprises the first conductive plate and the light-passing board that are integrally formed with conductive material.

According to the present invention, a light-passing board includes a first conductive plate connected to a photoelectric conversion device, and is provided with a light-passing portion that passes light to an area of the photoelectric conversion device where the light is emitted or received. For example, the light-passing portion of the light-passing board may be made of transparent resin to pass the light, or consist of a through hole that passes the light. As including the first conductive plate connected to the photoelectric conversion device, the light-passing board further includes a second conductive plate or a holding unit that holds this one and is transparent. The second conductive plate includes a light-passing portion, which may be an opening portion or a gap, at the position corresponding to the light-passing portion of the light-passing board. Thus, it is configured that the photoelectric conversion device can send and receive optical signals through the light-passing portion of the light-passing board, the light-passing portion of the second conductive plate, and the transparent holding unit.

Hence, it is possible to determine the width of the opening portion or the gap utilized as the light-passing portion of the second conductive plate, regardless of the width of a connector included in the photoelectric conversion device. Therefore, it is possible to make the second conductive plate become thicker for enhancing the strength of the connection terminal, even when the second conductive plate is exposed to the outside and utilized as the connection terminal.

According to the present invention, a lens is integrally formed on the transparent holding unit, and is arranged opposite to an area for receiving or emitting light in the photoelectric conversion device through the light-passing portion of the light-passing board and the light-passing portion of the second conductive plate. As describe above, the width of the light-passing portion in the second conductive plate can be determined regardless of the width of the connector in the photoelectric conversion device. Thus, the diameter of the lens can also be determined regardless of the width of the connector in the photoelectric conversion device. Therefore, it is possible to enhance the accuracy of the optical communication even with the increased size of the lens.

According to the present invention, another lens is integrally formed on the transparent holding unit, and is arranged at a position opposed to the position of the lens arranged opposite to the photoelectric conversion device. In other words, this another lens is arranged opposite to an optical fiber and the like. It is possible to simplify the manufacture processing of the optical communication module and reduce the manufacturing cost greater in the case that this another lens is formed integrally with the transparent holding unit, than in the case that this another lens is formed separately. It is preferred to match the centers of these two lenses integrally formed on the transparent holding unit.

According to the present invention, the first conductive plate and the second conductive plate are electrically connected, for example, with a wire. Therefore, it is possible to implement the transmission of electrical signals between the photoelectric conversion device connected to the first conductive plate and the communication circuit connected to the second conductive plate. The present invention is not limited to utilize the wire for electrically connecting the first conductive plate and the second conductive plate. For example, it may be configured that an electric conductor is arranged to penetrate the light-passing board from the top surface to the bottom surface (vertically) for implementing the electrical connection.

According to the present invention, it is possible to shield the components, such as the photoelectric conversion device and the light-passing board, from the external shock, because these components are sealed. For the sealing, synthetic resin may be utilized, or the components described above may be put into a recess portion that is covered later. The other method may be utilized for the sealing.

According to the present invention, the first conductive plate and the light-passing board are integrally formed with conductive material. In other words, it is configured that the first conductive plate has an enough thickness (similar to the thickness of the light-passing board) and the first conductive plate connected to the photoelectric conversion device is directly arranged on the holding unit, or that the light-passing board is made conductive to work as the first conductive plate and the photoelectric conversion device is connected to the light-passing board. For example, it is possible to utilize a leadframe as the integrally-formed component of the first conductive plate and the light-passing board. Thus, it is possible to reduce the number of parts required for the optical communication module.

According to the present invention, the photoelectric conversion device is arranged on the light-passing board mounting the first conductive plate, and the light-passing board is arranged on the transparent holding unit holding the second conductive plate. Furthermore, it is configured that the photoelectric conversion device performs the transmission of optical signals through the light-passing portion of the light-passing board, the light-passing portion of the second conductive plate and the transparent holding unit. Thus, it is possible to determine the width of the opening portion or the gap utilized as the light-passing portion of the second conductive plate, regardless of the width of the connector in the photoelectric conversion device. Therefore, it is possible to make the second conductive plate become thicker for enhancing the strength of the connection terminal, even when the second conductive plate is exposed to the outside and utilized as the connection terminal. Furthermore, the diameter of the lens can be determined regardless of the width of the connector in the photoelectric conversion device, when the lens is integrally formed on the transparent holding unit. Therefore, it is possible to enhance the accuracy of the optical communication with the increased size of the lens.

Therefore, it is possible to prevent reduction in the strength of the connection terminal of the optical communication module or the reduction in communication accuracy, and to implement the optical communication module that is highly reliable and has higher communication accuracy, even when the photoelectric conversion device is downsized.

### BRIEF DESCRIPTION OF THE DRAWINGS

FIG. 1 is a schematic cross section view showing a configuration of an optical communication module according to the present invention.

FIG. 2A is a schematic view showing a configuration of a photoelectric conversion device included in the optical communication module according to the present invention.

FIG. 2B is a schematic view showing another configuration of the photoelectric conversion device included in the optical communication module according to the present invention.

FIG. 2C is a schematic view showing another configuration of the photoelectric conversion device included in the optical communication module according to the present invention.

FIG. 3A is a schematic view showing a configuration of a light-passing board included in the optical communication module.

FIG. 3B is a schematic view showing another configuration of the light-passing board included in the optical communication module.

FIG. 4 is a schematic plain view showing a configuration of a conductive plate included in the optical communication module according to the present invention.

FIG. 5 is a schematic view for explaining a method for electrically connecting the conductive plate.

FIG. 6A is a schematic view for explaining configurations of the first lens and the second lens included in the optical communication module according to the present invention.

FIG. 6B is another schematic view for explaining configurations of the first lens and the second lens included in the optical communication module according to the present invention.

FIG. 6C is another schematic view for explaining configurations of the first lens and the second lens included in the optical communication module according to the present invention.

FIG. 7A is a schematic view for explaining a relationship between the size of the lens and light parallelism.

FIG. 7B is another schematic view for explaining the relationship between the size of the lens and light parallelism.

FIG. 8A is a schematic view for explaining the relationship between the existence of light-passing board and the size of the first lens.

FIG. 8B is another schematic view for explaining the relationship between the existence of light-passing board and the size of the first lens.

FIG. 9A is a schematic view showing a configuration of the light-passing board included in the optical communication module according to an alternative embodiment 1 of the present invention.

FIG. 9B is another schematic view showing a configuration of the light-passing board included in the optical communication module according to an alternative embodiment 1 of the present invention.

FIG. 10 is a schematic cross section view showing a configuration of the optical communication module according to the alternative embodiment 2 of the present invention.

FIG. 11 is a schematic cross section view for explaining an optical communication module that implements enhancement in the communication accuracy and reduction in the manufacturing cost.

### DESCRIPTION OF THE PREFERRED EMBODIMENTS

The present invention will be described in reference to figures that show Embodiments according to the present invention.

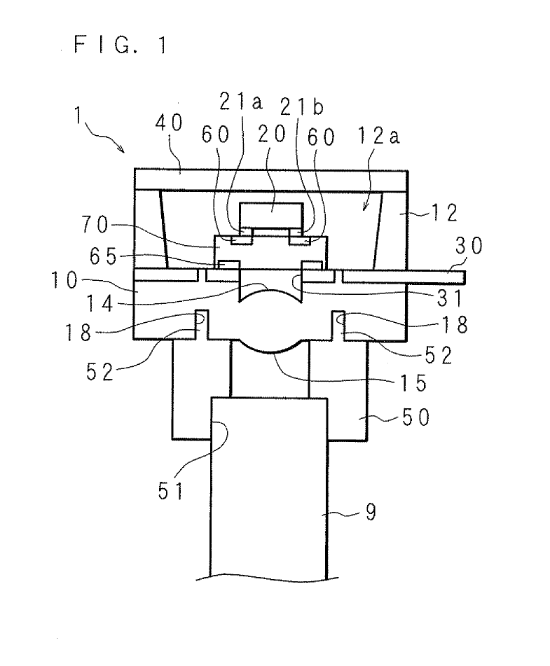

FIG. 1 is a schematic cross section view showing a configuration of an optical communication module according to the present invention. The numeral “1” in figures is an OSA into which a laser diode (photoelectric conversion device) 20 is packaged, and which corresponds to the optical communication module according to the present invention. The OSA 1 is a part that is connected to an optical fiber 9 and is used for optical communication, in which the laser diode 20 converts an electrical signal into an optical signal which is to be output to another device through the optical fiber 9.

The OSA 1 includes a base (holding unit) 10 that is formed in a plate shape and is a substantial square shape in a plain view. The OSA 1 further includes a conductive plate (second conductive plate) 30, a light-passing board 70, a laser diode 20 and the like at one side of the base 10 (top side in FIG. 1, hereinafter referred to as “top side” simply), and a cylindrical portion 50 connected to the optical fiber 9 at the opposite side (bottom side in FIG. 1, hereinafter referred to as “bottom side” simply). The base 10 and the light-passing board 70 are made of transparent synthetic resin. The base 10 includes a peripheral wall 12 along the periphery on the top surface. The top surface of the base 10 and the peripheral wall 12 configure a recess portion 12a that accommodates the laser diode 20 and is sealed by a cover 40.

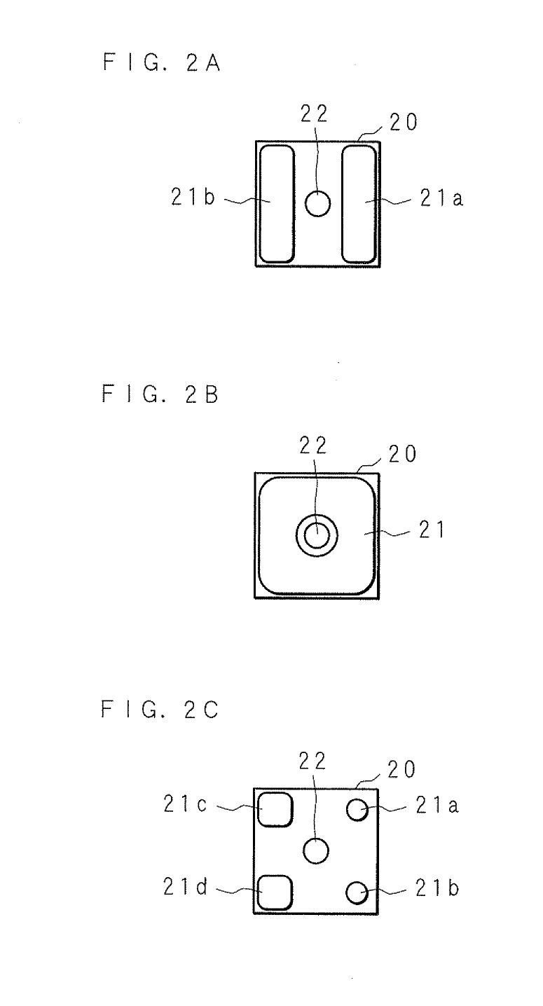

FIG. 2A, FIG. 2B and FIG. 2C are schematic views showing configurations of the photoelectric conversion device included in the optical communication module according to the present invention. Three configuration examples about the bottom side of the laser diode 20 are illustrated in FIG. 2A, FIG. 2B and FIG. 2C. The laser diode 20 is formed in a plate shape that is a substantial square shape in a plain view. The laser diode 20 includes a light emitting unit 22 at the substantial center on the bottom surface, and includes one or more connectors around the light emitting unit 22. The light emitting unit is to emit light in response to an input electrical signal. The connector is a terminal for inputting and outputting an electrical signal to the laser diode 20, and for connecting to the conductive plate 30 through the solder, conductive adhesive or the like.

For example, two connectors 21a, 21b may be arranged on the bottom surface of the laser diode 20 (See FIG. 2A). In that arrangement, each of the connectors 21a, 21b may be a substantial rectangular shape and sandwich the light emitting unit 22. For example, an annular connector 21 enclosing the light emitting unit 22 may be arranged on the bottom surface of the laser diode 20 (See FIG. 2B). In that arrangement, only one connector 21 can be provided on the bottom surface of the laser diode 20, although the laser diode 20 requires at least two terminals for inputting and outputting. Thus, another connector should be provided on the top surface, the side surface or the like of the laser diode 20. For example, dummy connectors 21c, 21d may be arranged in addition to two connectors 21a, 21b for inputting and outputting an electrical signal (See FIG. 2C). These dummy connectors 21c, 21d are utilized for connecting with solder, conductive adhesive or the like, but do not input or output an electrical signal. In that arrangement, four connectors 21a-21d may be kept at four corners on the bottom surface of the laser diode 20.

It should be noted that the following descriptions and figures are for explaining in the context of the OSA 1 provided with the laser diode 20 having two connectors 21a, 21b on the bottom surface as shown in FIG. 2A. However, the laser diode 20 in the OSA 1 may be configured to be as shown in FIG. 2B or FIG. 2C, or may have another configuration.

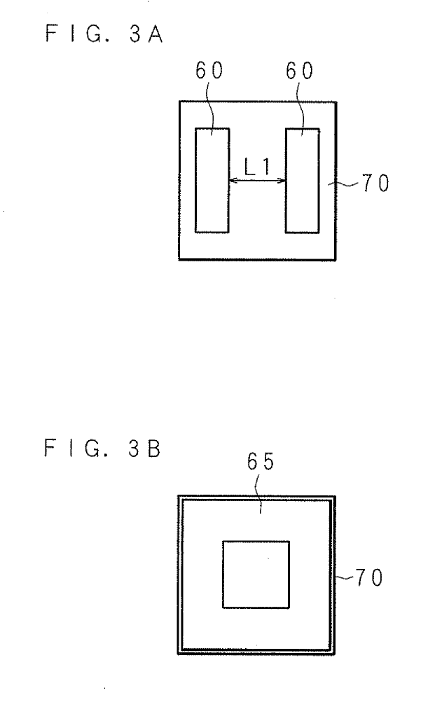

The connectors 21a, 21b of the laser diode 20 are fixed with the solder, the conductive adhesive or the like and connected to a conductive plate (first conductive plate) 60 arranged on the top surface of the light-passing board 70, to be arranged on the light-passing board 70 of the OSA 1. FIG. 3A and FIG. 3B are schematic views showing configurations of the light-passing board 70 included in the optical communication module. FIG. 3A illustrates a configuration of the top surface of the light-passing board 70, and FIG. 3B illustrates the bottom surface of the light-passing board 70. The light-passing board 70 is made of transparent synthetic resin, and is formed in a plate shape that is a substantial square larger than the laser diode 20 in the plain view.

Two conductive plates 60 are arranged in approximately parallel with each other on the top surface of the light-passing board 70, each of which is formed in a substantial rectangular shape. The conductive plate 60 is a rectangular plate, for example, made of metal and is embedded on the top surface of the light-passing board 70. The top surface of each conductive plate 60 is exposed to the top surface of the light-passing board 70, and each of the connectors 21a, 21b in the laser diode 20 is connected to the exposed portion. Thus, the distance L1 of two conductive plates 60 arranged on the light-passing board 70 depends on the distance of the connectors 21a, 21b of the laser diode 20.

An annular conductive plate 65 whose periphery is just like a square is embedded in the bottom surface of the light-passing board 70. The conductive plate 65 is a plate, for example, made of metal having an opening portion at the center and is embedded in the bottom surface of the light-passing board 70. The opening portion is formed in a substantial square shape. The bottom surface of the conductive plate 65 is exposed to the bottom surface of the light-passing board 70. The conductive plate 65 is fixed with the solder, the conductive adhesive or the like and connected to the conductive plate 30 arranged on the top surface of the base 10. The width of the opening portion at the conductive plate 65 is larger than the distance L1 of two conductive plates 60 arranged on the top surface of the light-passing board 70.

The light-passing board 70 is made of transparent synthetic resin. Thus, the laser diode 20 fixed to the top surface of the light-passing board 70 can pass the light emitted from the light emitting unit 22 to the outside through the gap between two conductive plates 60 arranged on the top surface of the light-passing board 70, the inside of the light-passing board 70, and the opening portion of the conductive plate 65 arranged on the bottom surface of the light-passing board 70 (In other words, the gap of the conductive plates 60, the transparent light-passing board 70 and the opening portion of the conductive plate 65 configure the light-passing portion of the light-passing board 70 that passes the light vertically).

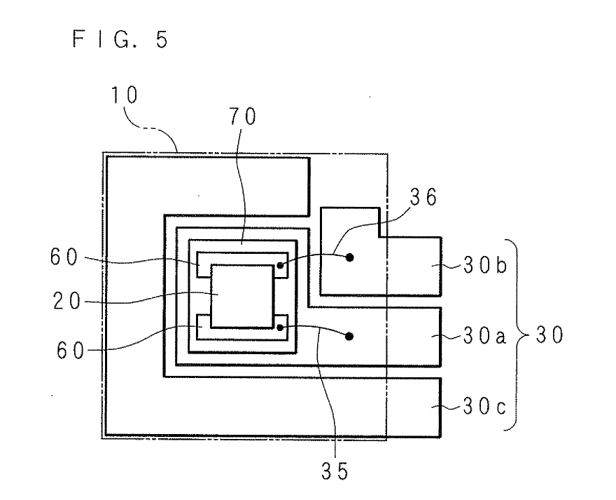

The base 10 of OSA 1 includes a conductive plate 30 that is made of metal and is embedded, and one surface of the conductive plate 30 is exposed inside the recess portion 12a. The exposed portion of the conductive plate 30 inside the recess portion 12a is connected with the solder, conductive adhesive or the like to the conductive plate 65 arranged on the bottom surface of the light-passing board 70. Furthermore, the exposed portion is connected through a wire (shown in FIG. 5 but omitted in FIG. 1) to the conductive plate 60 arranged on the top surface of the light-passing board 70. The conductive plate 60 and the conductive plate 30 are utilized for performing the transmission of electrical signals between the laser diode 20 and an external apparatus. In other words, the conductive plate 60 and the conductive plate 30 correspond to wires that connect components contained in the sending circuit including the laser diode 20.

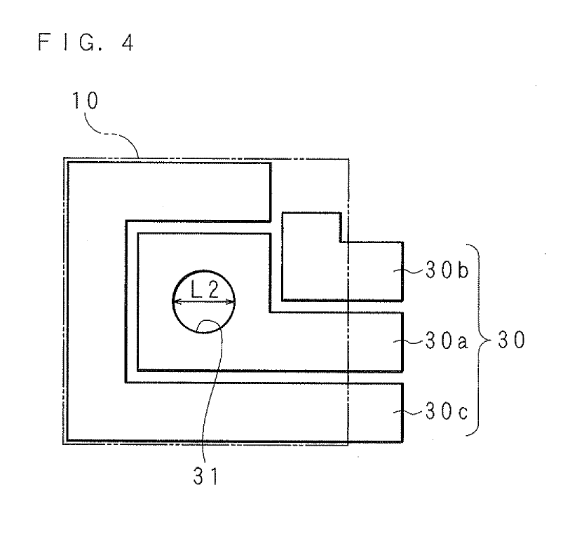

FIG. 4 is a schematic plain view showing a configuration of the conductive plate 30 included in the optical communication module according to the present invention. In FIG. 4, the outer shape of the base 10 is illustrated by two-dot chain line on the top surface shape of the conductive plate 30. In the example of FIG. 4, the OSA 1 includes three conductive plates 30a-30c. The conductive plate 30a includes a portion that is formed in a substantial square shape and is arranged at the center of the base 10, and a portion that extends from the square portion to the outside of the base 10. An opening portion 31 is formed in a substantial circular shape at the center of the square portion, and works as a light-passing portion for passing light in the vertical direction of the conductive plate 30a. The conductive plate 30a is embedded in the base 10 and the opening portion 31 is positioned at the substantial center of the base 10 in the plain view. The width (diameter) L2 of the opening portion 31 is longer than the distance L1 of the conductive plates 60 on the light-passing board 70 that is determined in view of the distance of the connectors 21a, 21b of the laser diode 20, but is similar to the width of the opening portion in the conductive plate 65 that is arranged at the bottom surface of the light-passing board 70. The light-passing board 70 is arranged on the conductive plate 30a, and the conductive plate 35 of the bottom surface is fixed to the conductive plate 30a with the solder, adhesive or the like. One conductive plate 60 arranged on the top surface of the light-passing board 70 is connected to the conductive plate 30a through the wire.

The conductive plate 30b is formed in a substantial “L” shape, and arranged adjacent to the conductive plate 30a. One end portion of the conductive plate 30b extends to the outside of the base 10. The conductive plate 30b is connected through the wire to one of the conductive plates 60 arranged on the top surface of the light-passing board 70. In addition, the conductive plate 30c is formed in a substantial “U” shape, and is arranged to surround the conductive plate 30a. One end portion of the conductive plate 30c extends to the outside of the base 10. For example, the conductive plate 30c is connected to the ground to be at the ground potential and utilized for shielding the OSA 1. The portions of the conductive plates 30a-30c extending from the base 10 are utilized as terminals, for example, for connecting the OSA 1 and a circuit board of a communication apparatus.

The base 10 holding the conductive plate 30 is transparent, and formed in a substantial square shape in the plain view. The base 10 includes a recess portion on the top surface. The recess portion is formed in a substantial circular shape and continues to the opening portion 31 of the conductive plate 30. A first lens 14 is arranged on the bottom part of the recess portion, and is formed in a convex shape extending to the top side. The base 10 includes a second lens 15 on the bottom surface, and the second lens 15 is formed in a convex shape. The first lens 14 and the second lens 15 are arranged on the base 10 to be opposite to each other in the vertical direction of the base 10, and the centers of these lenses match with each other. The position of the laser diode 20 is determined to match the center of the light emitting unit 22 with the center on the surface of the first lens 14, and the laser diode 20 is fixed to the conductive plate 60 of the light-passing board 70.

The peripheral wall 12 is also arranged along the periphery of the top surface of the base 10. The peripheral wall 12 is arranged to surround the light-passing board 70, the laser diode 20 and the like arranged on the top surface of the base 10. The peripheral wall 12 and the base 10 configure the recess portion 12a that accommodates the light-passing board 70, the laser diode 20 and the like. It is configured that the peripheral wall 12 is sufficiently higher than the heights of the light-passing board 70, the laser diode 20 and the like that are stacked on the top surface of the base 10.

The base 10, the peripheral wall 12, the first lens 14 and the second lens 15 of the OSA 1 are integrally formed with transparent synthetic resin. For example, the conductive plate 30 is previously formed in a desired shape, the formed conductive plate 30 is put into the mold tool, and then transparent liquid resin is poured into the mold tool and cured. In short, the integral formation can be obtained by so-called injection molding. The transparent synthetic resin for making the base 10 and the like can be selected regardless of the heat performance and the like of the laser diode 20. Therefore, it is possible to select synthetic resin that leads the high formation accuracy and is unlikely deformed in response to the peripheral environment such as a change in the temperature.

The OSA 1 includes a cover 40 that is fixed to the top end of the peripheral wall 12 arranged at the top surface side of the base 10 and seals the recess portion 12a. The cover 40 is formed in a substantial square shape in the plain view, similarly to the base 10. The cover 40 is fixed to the top end of the peripheral wall 12, for example, by the ultrasonic bonding or the adhesive method with the adhesive. The cover 40 may be transparent of non-transparent, and may be made of material the same as or different from the material of base 10, the peripheral wall 12 and the like. When the cover 40 is fixed, the inside of the recess portion 12a may be filled with gas, such as nitrogen gas or dry air, or may be evacuated.

Because the base 10 and the light-passing board 70 are made of transparent synthetic resin, the laser diode 20 connected to the conductive plate 60 arranged on the top surface of the light-passing board 70 can emit the light to the outside of the OSA 1 through the gap of the conductive plate 60, the transparent light-passing board 70, the opening portion of the conductive plate 65, the opening portion 31 of the conductive plate 30, the first lens 14, the transparent base 10 and the second lens 15.

The OSA 1 includes a cylindrical portion 50 connected to the bottom surface of the base 10. The cylindrical portion 50 is formed in a cylindrical shape and is fixed to the bottom surface of the base 10 to surround the second lens 15 arranged on the bottom surface of the base 10. The inner diameter of the cylindrical portion 50 at the bottom side is configured to be expanded stepwisely. Thus, the cylindrical portion 50 includes a top part whose inner diameter is shorter and a bottom part whose inner diameter is longer. As the top part of the cylindrical portion 50 has the shorter internal diameter, the internal diameter is equal to or a little longer than the diameter of the second lens 15. As the bottom part of the cylindrical portion 50 has the longer internal diameter, the internal diameter is similar to the diameter of an optical fiber 9. In addition, the bottom part includes a fitting portion 51 to which the optical fiber 9 is fit.

At the end surface of the top side, the cylindrical portion 50 includes plural connection pins 52 each of which is formed in a rod shape. Plural connection pins 52 are equally spaced from each other in the circumferential direction on the end surface of the cylindrical portion 50. On the bottom surface, the base 10 includes plural connection holes 18 into which the connection pins 52 are inserted for connecting the cylindrical portion 50. The positions of connection pin 52 in the cylindrical portion 50 and the position of connection hole 18 in the base 10 are precisely determined to match the center of the cylindrical portion 50 with the center of the second lens 15 when the connection pin 52 is inserted into the connection hole 18 and the cylindrical portion 50 is connected to the base 10. The cylindrical portion 50 may be made of synthetic resin or other material, such as metal or wood. Although the connection of the cylindrical portion 50 can be obtained by insertion of the connection pin 52 into the connection hole 18, it is also possible to utilize adhesive for making further secured connection.

The positions of connection pin 52 and the position of connection hole 18 are precisely determined to to match the center of the cylindrical portion 50 with the center of the second lens 15 when the connection pin 52 is inserted into the connection hole 18 and the cylindrical portion 50 is connected to the bottom surface of the base 10. The shape of the fitting portion 51 in the cylindrical portion 50 is precisely formed such that the center of the cylindrical portion 50 matches with the center of the optical fiber 9 when the optical fiber 9 is fit to the fitting portion 51 of the cylindrical portion 50. Therefore, it is possible to match the center of second lens 15 with the center of the optical fiber 9. Furthermore, because the center of the first lens 14 is kept to match the center of the second lens 15 during the formation of the base 10 and the like while the position of the laser diode 20 is determined to match the center of the light emitting unit 22 in the laser diode 20 with the center of the first lens 14, it is possible to match the center of light emitting unit 22 in the laser diode, the center of the first lens 14, the center of the second lens 15 and the center of the optical fiber 9, and to precisely focus the light emitted from laser diode 20 on the optical fiber 9.

In the manufacturing process of the OSA 1, it is configured to separately manufacture the base 10, the peripheral wall 12, the light-passing board 70, the cover 40, the cylindrical portion 50 and the like. Because the conductive plate 30 previously manufactured from the metal plate to have the desired shape (see FIG. 4) is put into the mold tool for the injection molding and the transparent synthetic resin is poured into the mold tool and cured, it is possible to obtain the integral configuration of the base 10 holding the conductive plate 30, the peripheral wall 12, the first lens 14, the second lens 15, the connection hole 18 and the like.

Furthermore, because the conductive plate 60 and the conductive plate 65 previously manufactured from the metal plates to have the desired shapes (see FIG. 3A and FIG. 3B) are put into the mold tool for the injection molding and the transparent synthetic resin is poured into the mold tool and cured, it is possible to obtain the light-passing board 70 where the conductive plate 60 is embedded in the top surface and the conductive plate 65 is embedded in the bottom surface. For example, the cover 40 can be manufactured by cutting a plate made of synthetic resin into pieces having desired shapes. The cylindrical portion 50 can be manufactured by pouring synthetic resin into the mold tool for the injection molding and then curing it.

After the above parts are separately manufactured, these plural parts are connected and fixed to configure the OSA 1. At first, the conductive plate 30 exposed to the top surface of the base 10 is fixedly connected by the solder, the adhesive or the like to the conductive plate 65 exposed to the bottom surface of the light-passing board 70. It is not required to precisely determine the position of the light-passing board 70 with respect to the base 10 at that time. Then, the conductive plate 60 exposed to the top surface of the light-passing board 70 is fixedly connected by the solder, the conductive adhesive or the like to the connectors 21a, 21b of the laser diode 20 to mount the laser diode 20. At that time, the position of the laser diode 20 is precisely determined to match the center of the light emitting unit 22 with the center of the first lens 14. The positional determination of the laser diode 20 may be performed in reference directly to the center of the first lens 14, or in reference to a specific portion on the top surface of the base 10 formed the mold tool utilized for forming the first lens 14.

Then, the conductive plate 30 of the base 10 is electrically connected to the conductive plate 60 of the light-passing board 70. FIG. 5 is a schematic view for explaining a method for electrically connecting the conductive plates 30 and 60. In FIG. 5, the peripheral wall 12 and the cover 40 are omitted, and OSA 1 viewed from the top surface is schematically illustrated. One of two conductive plates 60 arranged on the top surface of the light-passing board 70 is electrically connected through a wire 35 to the conductive plate 30a supported by the base 10. The other one of two conductive plates 60 is electrically connected through a wire 36 to the conductive plate 30b supported by the base 10. Thus, the connectors 21a, 21b of the laser diode 20 connected to the conductive plate 60 of the light-passing board 70 are electrically connected to the conductive plates 30a, 30b exposed to the outside of the OSA 1. Therefore, it is possible to perform the transmission of electrical signals between the laser diode 20 and an external communication apparatus or the like.

After the connection with the wires 35, 36 is completed, the recess portion 12a configured with the base 10 and the peripheral wall 12 of the OSA 1 is sealed by the cover 40. The cover 40 is fixed to the top side of the peripheral wall 12 by a method, such as ultrasonic bonding or adhesion with adhesive. Thus, the laser diode 20 is isolated from the outside. Gas may be filled in the recess portion 12a before the cover 40 is fixed to the peripheral wall 12.

Then, the connection pin 52 is inserted into the connection hole 18 arranged on the bottom surface of the base 10, to connect the cylindrical portion 50 to the base 10. At that time, the adhesive may be applied to the connection pin 52, the connection hole 18, the top end surface of the cylindrical portion 50, the bottom surface of the base 10 or the like before the connection pin 52 is inserted into the connection hole 18, for fixing the cylindrical portion 50 to the base 10.

It is possible to utilize these steps for manufacturing the OSA 1. In the OSA 1 of the present invention, after the base 10 and the light-passing board 70 are separately formed with transparent synthetic resin and assembled, the position of the laser diode 20 is determined to connect the laser diode 20 to the conductive plate 60 and then the cover 40 is utilized for the sealing. Hence, it is possible to select the transparent synthetic resin, which configures the base 10 and the light-passing board 70, regardless of the heat performance of the laser diode 20 and the like. Therefore, it is possible to select the synthetic resin that can implement precise forming of each part, and to enhance the accuracy level for forming the base 10, the light-passing board 70 and the like.

As described above, the mold tool is necessary for forming the base 10, the first lens 14, the second lens 15 and the like with the transparent synthetic resin by the injection molding method. In addition, two mold tools are necessary for forming the top side of the base 10 and the bottom side of the base 10, in order to integrally form the base 10 described above and the like. Thus, it may cause aberration between the top side and the bottom side of the formed base 10, if the positional shift is caused to the top and bottom mold tools. The OSA 1 according to the present invention is configured to prevent the accuracy of the optical communication from being reduced even when the aberration is caused to the top surface side and the bottom surface side of the base 10 due to the positional shift of the mold tools.

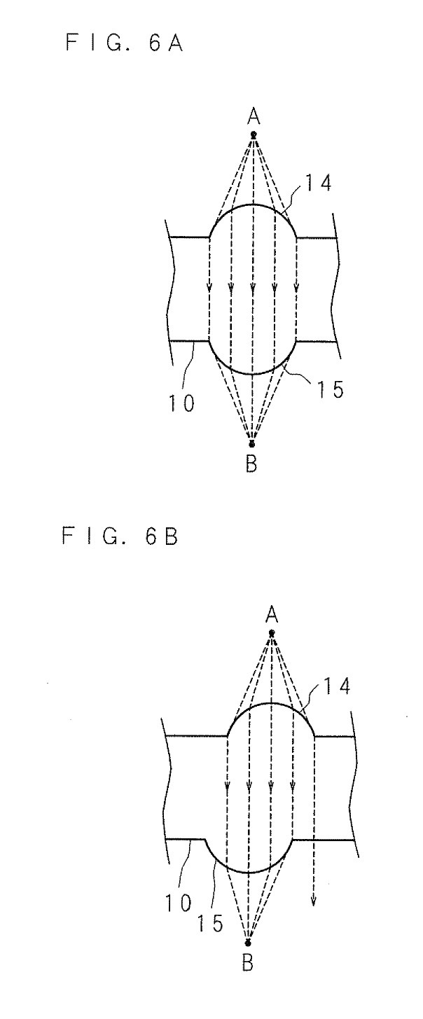

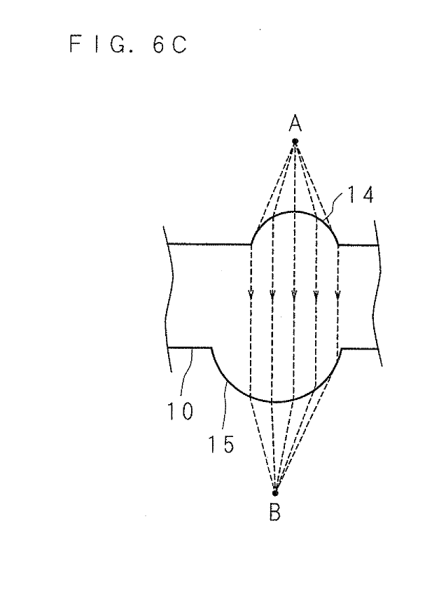

FIG. 6A, FIG. 6B and FIG. 6C are schematic views for explaining configurations of the first lens 14 and the second lens 15 included in the optical communication module according to the present invention. Only the base 10, the first lens 14 and the second lens 15 are extracted and schematically illustrated in these figures. In these figures, the point “A” represents the light emitting unit 22 of the laser diode 20, and the point “B” represents the end of the optical fiber 9. FIG. 6A illustrates the case that the center of the first lens 14 matches to the center of the second lens 15, while FIG. 6B and FIG. 6C illustrate the cases that the aberration is caused for the center of the first lens 14 and the center of the second lens 15.

The light emitted from the light emitting unit 22 of the laser diode 20 is broadened in a predetermined range from the exit terminal (point A) and reaches to the first lens 14. The first lens 14 has the convex surface whose shape is determined to convert the light emitted from the light emitting unit 22 of the laser diode 20 into the substantial parallel light, in consideration of the distance to the light emitting unit 22. Thus, the light emitted from the light emitting unit 22 of the laser diode 20 is converted into the substantial parallel light by the first lens 14, passes the inside of the transparent base 10 and then reaches to the second lens 15. The second lens 15 has the convex surface whose shape is determined to focus the parallel light coming through the base 10 on the end portion (point B) of the optical fiber 9, in consideration of the distance to the optical fiber 9.

In the case that the center of the first lens 14 matches to the center of the second lens 15 (see FIG. 6A), the light coming from the light emitting unit 22 of the laser diode 20 to the first lens 14 is converted into the substantial parallel light by the first lens 14, passes the inside of the base 10 and reaches to the second lens 15. The light reaching to the second lens 15 is focused on the end portion of the optical fiber 9.

In the case that the center of the first lens 14 does not match to the center of the second lens 15 (see FIG. 6B), the light coming from the light emitting unit 22 of the laser diode 20 to the first lens 14 is converted into the substantial parallel light by the first lens 14, passes inside the base 10, and reaches to the second lens 15. The light reached to the second lens 15 is focused on the end portion of the optical fiber 9.

In short, regardless of the match between the center of the first lens 14 and the center of the second lens 15, the light coming from the light emitting unit 22 of the laser diode 20 to the first lens 14 is converted into the substantial parallel light by the first lens 14, passes inside the base 10, and thus the light reached to the second lens 15 is focused on the end of the optical fiber 9. Thus, it is possible to surely focus the light emitted from the light emitting unit 22 of the laser diode 20 on the optical fiber 9 in the OSA 1 of the present invention, even in the case that the aberration is caused to the centers of the first lens 14 and the second lens 15. Therefore, it is possible to prevent reduction in the accuracy of the optical communication due to the aberration.

When the aberration is caused to the centers of the first lens 14 and the second lens 15 in the case that the second lens 15 is equal to or smaller than the first lens 14, a part of the substantial parallel light converted by the first lens 14 is emitted to the outside of the base 10 without reaching to the second lens 15. Thus, it may cause the reduction in the amount of light focused on the optical fiber 9. However, it is possible to perform the optical communication with a proper accuracy level when the aberration amount is not large about the centers of the first lens 14 and the second lens 15, because no shift is caused in the position of the optical fiber 9 where the light is focused by the second lens 15.

In order to address the reduction of the light amount, the second lens 15 may be configured larger than the first lens 14 to which the light comes from the light emitting unit 22 of the laser diode 20, as the second lens 15 directs the light to the optical fiber 9 (see FIG. 6C). Thus, the light converted into the substantial parallel light by the first lens 14 surely reaches to the optical fiber 9. Therefore, it is possible to make the second lens 15 focus the whole light coming into the first lens 14 on the optical fiber 9.

In the case that the OSA 1 utilizes a photodiode, instead of the laser diode 20, to receive the optical signal, the reduction of the light amount caused by the positional shift of the centers of the first lens 14 and the second lens 15 is prevented by the configuration that the first lens 14 is larger than the second lens 15. In other words, the lens to which the light from the light source comes may be formed larger than the other lens that focuses and directs the parallel light passed through the base 10 to an object.

As described above, the integral formation of lenses on the both sides of the transparent base 10 can implement the parallel light passing in the base 10. Therefore, the OSA 1 can perform the transmission of optical signals with higher accuracy than the case that only one of the lenses is integrally formed. In addition, it is possible to obtain higher parallelism for the light passing inside the base 10, as the size (diameter) of the lens at the light emitting side, i.e., the size (diameter) of the first lens 14 at the side of laser diode 20 becomes larger.

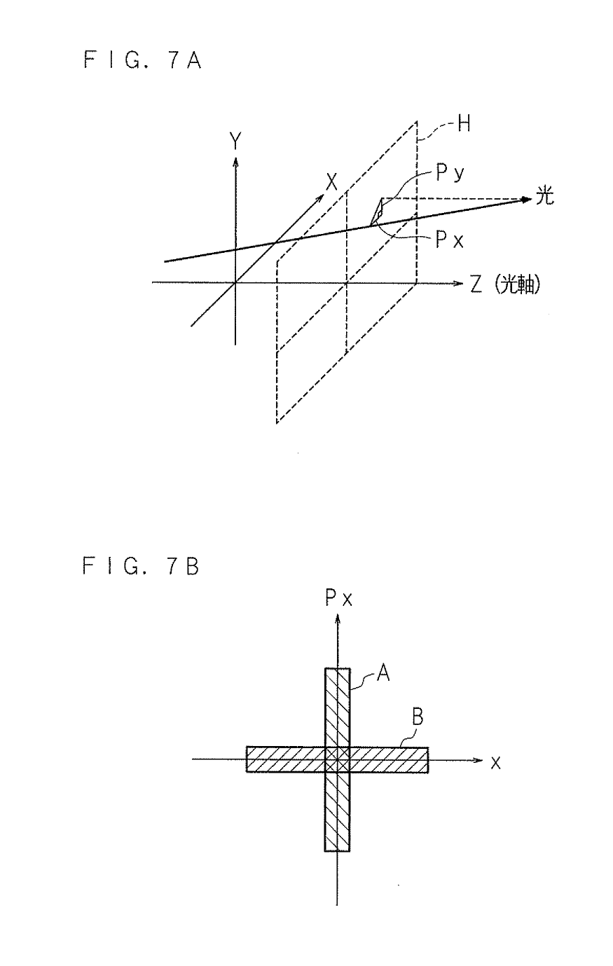

FIG. 7A and FIG. 7B are schematic views for explaining a relationship between the size of the lens and the light parallelism. In FIG. 7A, the light emitted from the light emitting unit 22 of the laser diode 20 is represented by a thick arrow in the three dimensional space where the optical direction for the light emitting unit 22 of the laser diode 20, the first lens 14 and the second lens 15 corresponds to the Z axis and the directions perpendicular to the optical direction correspond to the X axis and the Y axis. It should be noted that the “(x, y)” represents an intersecting point of a plane H, which is perpendicular to a light axis located at an arbitrary distance from the light emitting unit 22 of laser diode 20, and an emitted light's vector. In addition, the “(x1, y1)” represents an intersecting point of the plane H and a perpendicular line from the emitted light's vector to the plane H, and the difference between these two points is represented by (Px, Py)=(x1, y1)−(x, y).

FIG. 7B illustrates the distribution of (Px, x) about all the light emitted from the light emitting unit 22 of the laser diode 20, in respect to only the component in the X direction. The area A represents the distribution of the light immediately after the emission from the light emitting unit 22 of the laser diode 20, and the area B represents the distribution of the light that is converted into the parallel light by the first lens 14. It should be noted that the light parallelism is higher as the area in the Px direction is smaller and the area in the x direction is larger in FIG. 7B. The area A is substantially equal to the area B. Thus, it is possible to make the light parallelism become higher as the distribution is widened in the x direction. In short, the light parallelism higher as the size of the first lens 14 is larger.

In the optical communication module (OSA 101) of FIG. 11 described above, the size of the opening portion 31 in the conductive plate 30 is limited by the arrangement of the connector 21 included by the laser diode 20 and further the size of the first lens 14 is limited by the size of the opening portion 31. Thus, it is difficult to enlarge the opening portion 31. Therefore, the optical communication module (OSA 1) according to the present invention utilizes the light-passing board 70 to implement enlargement of the first lens 14.

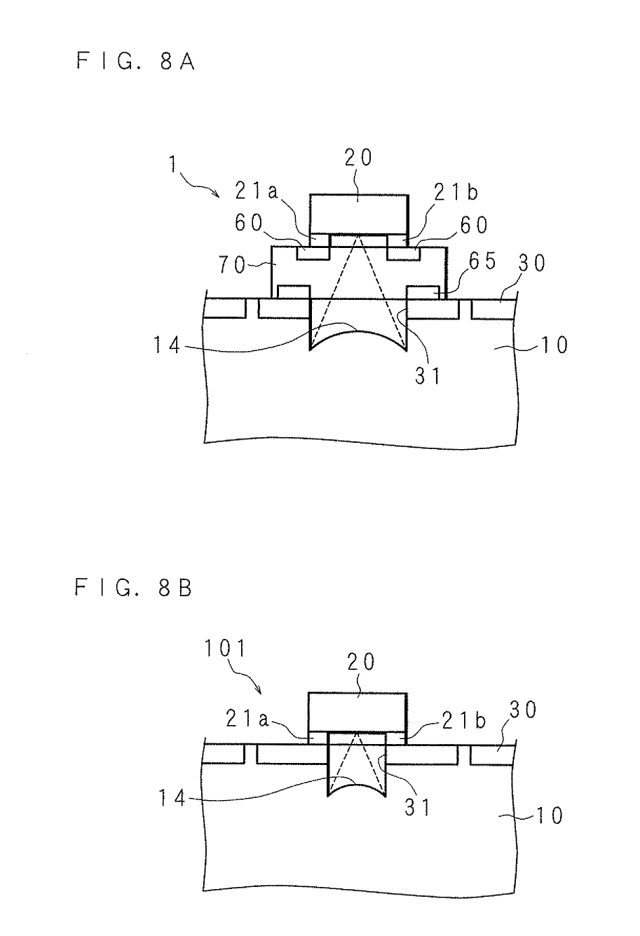

FIG. 8A and FIG. 8B are schematic views for explaining the relationship between the existence of the light-passing board 70 and the size of the first lens 14. FIG. 8A illustrates the enlarged configuration having the light-passing board 70 (similar to the configuration of FIG. 1), and FIG. 8B illustrates the enlarged configuration not having the light-passing board 70 (similar to the configuration of FIG. 11). As described above, the width of the opening portion 31 in the conductive plate 30 is limited by the widths of the connectors 21a, 21b included by the laser diode 20 and further the size of the first lens 14 is limited by the width of the opening portion 31, in the case that the light-passing board 70 is not utilized. Thus, the first lens 14 must be downsized in response to the downsizing of the laser diode 20 (see FIG. 8B).

On the other hand, when the light-passing board 70 is utilized, the connectors 21a, 21b of the laser diode 20 are not directly connected to the conductive plate 30 embedded in the base 10. Thus, the width of the conductive plate 30 is not limited by widths of the connectors 21a, 21b, and hence the width of the first lens 14 is not limited (see FIG. 8A). Therefore, the size of the first lens 14 can be determined in consideration of the communication accuracy required for the OSA 1, and then the width, the thickness and the like of the light-passing board 70 can be determined in reference to the size of the first lens 14.

In the OSA 1 described above, the laser diode 20 is fixed and connected to the conductive plate 60 arranged on the top surface of the transparent light-passing board 70, and the light-passing board 70 is fixed and connected to the conductive plate 30 arranged on the top surface of the transparent base 70. Thus, the laser diode 20 can perform the transmission of optical signals through the gap of the conductive plate 60, the transparent light-passing board 70, the opening portion of the conductive plate 65, the opening portion 31 of the conductive plate 30, the first lens 14, the transparent base 10, and the second lens 15. That configuration prevents the widths of the connector s 21a, 21b in the laser diode 20 from limiting the width of the opening portion 31 of the conductive plate 30. Hence, it is not required to narrow the width of the opening portion 31 in response to the downsizing of the laser diode 20, and to make the conductive plate 30 become thinner. Therefore, it is possible to make the conductive plate 30 have enough thickness to enhance the strength, even in the case that the portion of the conductive plate 30 exposed to the outside of the base 10 is utilized as the connection terminal for connecting to an external device.

In addition, because it is not required to downsize the first lens 14 in response to the downsizing of the laser diode 20 in that configuration, the diameter of the first lens 14 can be made larger than the gap width of the conductive plates 60 on the top surface of the light-passing board 70. Therefore, it is possible to prevent the downsizing of the laser diode 20 from reducing the communication accuracy of the OSA 1, and to implement the optical communication having higher accuracy with the OSA 1.

In addition, the first lens 14 is integrally formed on the top surface of the transparent base 10, the second lens 15 is integrally formed on the bottom surface of the transparent base 10, and the laser diode 20 performs the transmission of optical signals through the first lens 14 and the second lens 15. Thus, the light emitted by the laser diode 20 can be converted into the parallel light by the first lens 14, the parallel light can be directed to pass inside the base 10, and the directed light can be focused on the optical fiber 9 by the second lens 15. Therefore, it is possible to surely collect the light onto the optical fiber 9 and to prevent the reduction of the communication accuracy, even when the center of the first lens 14 is shifted in some degree from the center of the second lens 15. Furthermore, it is possible to simplify the manufacturing processing of the OSA 1 and reduce the manufacturing cost, in comparison with the case that the first lens 14 and the second lens 15 are separately manufactured.

In addition, the conductive plate 60 on the top surface of the light-passing board 70 is electrically connected with the wires 35, 36 in the recess portion 12a to the conductive plate 30 exposed to the outside of the base 10. Therefore, the laser diode 20 can be electrically connected to the conductive plate 30 and the laser diode 20 can perform the transmission of electrical signals with an external device through the conductive plate 30 exposed to the outside. Furthermore, because the cover 40 is attached to the recess portion 12a to seal the laser diode 20, the conductive plate 30, the light-passing board 70 and the like, it is possible to avoid the shock on these components and prevent a failure.

In this embodiment, the OSA 1 is illustrated to include the laser diode 20 as the photoelectric conversion device for emitting light. However, the present invention is not limited to the illustration. The OSA 1 may include a photodiode or the like as the photoelectric conversion device for receiving light. In addition, the OSA 1 in this embodiment is illustrated to include one photoelectric conversion device in the recess portion 12a. However, the present invention is not limited to the illustration. The OSA 1 may include a plurality of photoelectric conversion devices. When including the photodiode and the laser diode together as the plurality of photoelectric conversion devices, the OSA 1 can emit and receive light for the transmission of optical signals.

In addition, the conductive plate 65 is illustrated to be arranged on the bottom surface of the light-passing board 70. However, the present invention is not limited to the illustration. The conductive plate 65 may not be arranged on the bottom surface of the light-passing board 70, and the light-passing board 70 may be fixed to the base 10 or the conductive plate 30, for example, with an adhesive. In addition, it is illustrated that the conductive plate 60 on the top surface of the light-passing board 70 is electrically connected with the wires 35, 36 to the conductive plate 30 of the base 10. However, the present invention is not limited to the illustration. For example, an electric conductor may be embedded in the light-passing board 70 to penetrate the light-passing board 70 vertically and to electrically connect the conductive plate 60 and the conductive plate 65, and thus the light-passing board 70 may be electrically connected to the conductive plate 30. Even in that example case, the conductive plate 60 can be electrically connected to the conductive plate 30.

In addition, it is illustrated that the opening portion 31 is formed in the conductive plate 30 as the light-passing portion that passes the light vertically. However, the present invention is not limited to the illustration. For example, it may be configured that the light passes the gap of conductive plates 30, similarly to the conductive plates 60 of the light-passing board 70. In addition, it is illustrated that the cylindrical portion 50 is manufactured separately from the base 10 and connected to the base 10. However, the present invention is not limited to the illustration. The cylindrical portion 50 may be formed integrally with the base 10.

The configurations of the conductive plates 60, 65 on the light-passing board 70 shown in FIG. 3A and FIG. 3B are just the examples, and the present invention is not limited to the examples. The configuration of the conductive plate 30 (30a-30c) shown in FIG. 4 is just an example, and the present invention is not limited to the example. In addition, it is illustrated that the peripheral wall 12 is arranged on the top surface of the base 10 to configure the recess portion 12a and the recess portion 12a is sealed by the cover 40 to seal the laser diode 20, the light-passing board 70 and the like. However, the present invention is not limited to the illustration. Another method may be utilized for the sealing. For example, these components are sealed with resin.

It is illustrated that only the laser diode 20 is arranged in the recess portion 12a. However, the present invention is not limited to the illustration. Another circuit component (such as a resistor, a capacitor, a coil or an integrated circuit [IC]) may be arranged in the recess portion 12a for configuring the electric circuit. At that time, another circuit component described above may be connected to the conductive plate 60 of the light-passing board 70, or to the conductive plate 30 of the base 10. Said another circuit component may be connected with a wire to the conductive plate 30 or the conductive plate 60.

### Alternative Embodiment 1

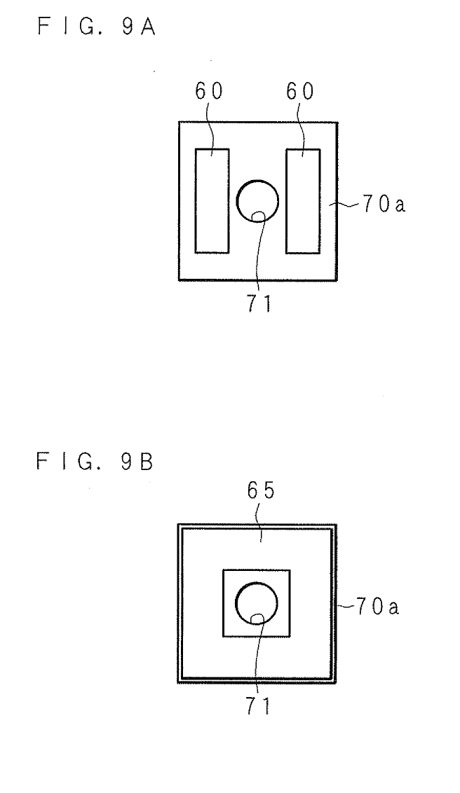

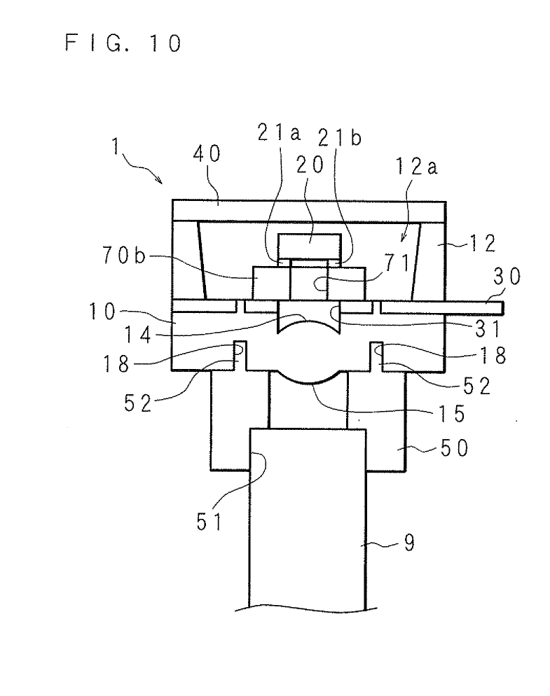

FIG. 9A and FIG. 9B are schematic views showing configurations of the light-passing board 70a included in the optical communication module according to an alternative embodiment 1 of the present invention. FIG. 9A illustrates the top surface's configuration of the light-passing board 70a, and FIG. 9B illustrates the bottom surface's configuration of the light passing board 70a. The light-passing board 70 shown in FIG. 3A and FIG. 3B described above is made of transparent synthetic resin, and the main body of the light-passing board 70 works as the light-passing portion that passes light. However, the present invention is not limited to the light-passing board 70. The light-passing board 70a according to the alternative embodiment 1 is made of non-transparent synthetic resin and includes a light-passing hole 71 at the substantial center in the plain view. The light-passing hole 71 is formed in a substantial circular shape. Therefore, the laser diode 20 connected to the conductive plate 60 arranged on the top surface of the light-passing board 70a can output optical signals through the light-passing hole 71.

In FIG. 9A and FIG. 9B, the light-passing hole 71 of the light-passing board 70a is illustrated to be formed in a substantial circular shape having a constant diameter. However, the present invention is not limited to the illustration. The diameter of the light-passing hole 71 may be enlarged stepwisely from the top side to the bottom side. In other words, the light-passing hole 71 may be formed in a truncated cone shape. The light-passing hole 71 may have a substantial circular shape in a plain view or another shape, such as a substantial rectangular shape.

### Alternative Embodiment 2

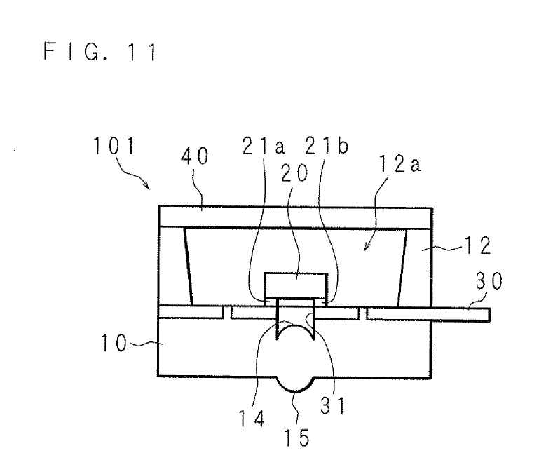

FIG. 10 is a schematic cross section view showing a configuration of the optical communication module according to the alternative embodiment 2 of the present invention. The light-passing board 70b of the OSA 1 according to the alternative embodiment 2 is formed in a plate shape having a substantial square shape in a plan view larger than the laser diode 20, and is made of metal. Thus, the light-passing board 70b includes the circular light-passing hole 71 at the substantial center in the plain view, but is not transparent.

In short, the light-passing board 70b of the alternative embodiment 2 is configured with the light-passing board 70a according to the alternative embodiment 1 shown in FIG. 9A and FIG. 9B and the conductive plates 60, 65. In other words, the light-passing board 70b of the alternative embodiment 2 may be the modified light-passing board 70a of the alternative embodiment 1 that is made of metal, and thus includes the functions of the conductive plates 60, 65. Alternatively, the light-passing board 70b of the alternative embodiment 2 may be the modified conductive plate 60 or conductive plate 65 of the alternative embodiment 1 that has the thickness similar to the thickness of the light-passing board 70a and thus includes the function of the light-passing board 70a.

The laser diode 20 in the OSA 1 according to the alternative embodiment 2 includes the light emitting unit 22 at the center of the bottom surface as shown in FIG. 2B, includes an annular connector 21 around the light emitting unit 22, and includes a terminal (not shown) on the top surface for connecting the laser diode 20 to the conductive plate 30 through a wire (not shown). The position of the laser diode 20 is determined with respect to the light-passing board 70b, to match the centers of the light emitting unit 22 and the light-passing hole 71. The laser diode 20 is then connected with the connector 21 to the top surface of the light-passing board 70b and fixed to top surface of the light-passing board 70b with solder, conductive adhesive or the like.

In addition, the light-passing board 70b is connected and fixed to the top surface of the conductive plate 30 exposed to the inside of the recess portion 12a in the base 10 with solder, conductive adhesive or the like. The connection of the laser diode 20 and the light-passing board 70 may be conducted earlier than the connection of the light-passing board 70b and the conductive plate 30, or vice versa.

As described above, the metal light-passing board 70b does not require arranging the conductive plates 60, 65 on the top and bottom surfaces. Therefore, it is possible to simplify the manufacturing of the light-passing board 70b and thus to simplify the manufacturing of the OSA 1.

### EXPLANATION OF ITEM NUMBERS

1 OSA (optical communication module)
9 optical fiber
10 base (holding unit)
12 peripheral wall
12a recess portion
14 first lens (lens)
15 second lens (another lens)
18 connection hole
20 laser diode (photoelectric conversion device)
21, 21a-21d connector
22 light emitting unit (area)
30, 30a-30c conductive plate (second conductive plate)
31 opening portion (light-passing portion)
35, 36 wire (connecting means)
40 cover (sealing means)
50 cylindrical portion
51 fitting portion
52 connection pin
60 conductive plate (first conductive plate)
65 conductive plate
70, 70a, 70b light-passing board
71 light-passing hole (light-passing portion)

1-6. (canceled)

7. An optical communication module, comprising:
a photoelectric conversion device that converts an optical signal to an electrical signal, or an electrical signal to an optical signal;
a light-passing board that includes a first conductive plate electrically connected to the photoelectric conversion device and a first light-passing portion for passing light coming to or from the photoelectric conversion device; and
a holding unit that holds a second conductive plate and supports the light-passing board, wherein
the holding unit includes a second light-passing portion whose position corresponds to a position of the first light-passing portion, and
the optical communication module utilizes a circuit component electrically connected to the second conductive plate and the light passed through the first and the second light-passing portions, to perform a transmission of the optical signal.

8. An optical communication module according to claim 7, further comprising:
an optical fiber that is utilized for the transmission of the optical signal, wherein
the optical fiber is optically connected to the photoelectric conversion device through the first and the second light-passing portions.

9. An optical communication module according to claim 7, wherein
the photoelectric conversion device includes an area for receiving or emitting light and a connector for connecting to another part, and
the first conductive plate is electrically connected to the connector.

10. An optical communication module according to claim 8, further comprising:
a lens that is integrally formed on the holding unit, wherein
the lens is arranged opposite to the area through the first and the second light-passing portions.

11. An optical communication module according to claim 10, further comprising:
another lens that is integrally formed on the holding unit, wherein
said another lens is arranged opposite to the lens, and
the optical fiber is optically connected to the photoelectric conversion device through the first and the second light-passing portions, the lens and said another lens.

12. An optical communication module according to claim 7, further comprising:
a means for electrically connecting the first conductive plate and the second conductive plate.

13. An optical communication module according to claim 7, further comprising:
a sealing means for sealing the photoelectric conversion device and the light-passing board.

14. An optical communication module according to claim 7, wherein
the first conductive plate and the light-passing board are integrally formed with conductive material.

15. An optical communication module according to claim 8, further comprising:
a means for, electrically connecting the first conductive plate and the second conductive plate.

16. An optical communication module according to claim 8, further comprising:
a sealing means for sealing the photoelectric conversion device and the light-passing board.

17. An optical communication module according to claim 8, wherein
the first conductive plate and the light-passing board are integrally formed with conductive material.

18. An optical communication module according to claim 9, further comprising:
a means for electrically connecting the first conductive plate and the second conductive plate.

19. An optical communication module according to claim 9, further comprising:
a sealing means for sealing the photoelectric conversion device and the light-passing board.

20. An optical communication module according to claim 9, wherein
the first conductive plate and the light-passing board are integrally formed with conductive material.

21. An optical communication module according to claim 11, further comprising:
a means for electrically connecting the first conductive plate and the second conductive plate.

22. An optical communication module according to claim 11, further comprising:
a sealing means for sealing the photoelectric conversion device and the light-passing board.

23. An optical communication module according to claim 11, wherein
the first conductive plate and the light-passing board are integrally formed with conductive material.
